(19) United States
(12) Patent Application Publication
(10) Pub. No.: US 2015/0315957 A1
(43) Pub. Date: Nov. 5, 2015

(54) Compression Ignition Engine with Staged Ignition

(71) Applicants: Wisconsin Engine Research Consultants LLC, Madison, WI (US); Caterpillar Inc., Peoria, IL (US)

(72) Inventors: Michael Joseph Bergin, Madison, WI (US); David D. Wickman, Madison, WI (US); Christopher James Rutland, Madison, WI (US); Rolf Deneys Reitz, Madison, WI (US)

(73) Assignees: Caterpillar Inc., Peoria, IL (US); Wisconsin Engine Research Consultants LLC, Madison, WI (US)

(21) Appl. No.: 14/266,766

(22) Filed: Apr. 30, 2014

(51) Int. Cl. F02B 17/00

(52) U.S. Cl. CPC F02B 17/005

(57) ABSTRACT

A compression ignition engine includes a piston having a barrier protruding axially therefrom. The barrier at least partly defines a combustion chamber having a first zone separated from a second zone by the barrier. An initial fuel charge is supplied into the combustion chamber, and a subsequent fuel charge is supplied into the first zone, the subsequent fuel charge having greater reactivity than the initial fuel charge. The fuel charges are compressed to induce ignition and combustion of the fuel charges, such that the subsequent fuel charge burns within the first zone to produce hot gases, and the hot gases flow across the barrier to effect combustion of the initial fuel charge within the second zone.

### STATEMENT AS TO RIGHTS TO INVENTIONS MADE UNDER FEDERALLY SPONSORED RESEARCH AND DEVELOPMENT

This invention was made with government support under Contract DE-EE0005423 awarded by the U.S. Department of Energy (DOE). The government has certain rights in the invention.

### CROSS REFERENCES TO RELATED APPLICATIONS

Not applicable.

### BACKGROUND OF THE INVENTION

The present disclosure relates to internal combustion engines generally, and more particularly to compression ignition combustion engines.

Internal combustion engines may be broadly categorized as spark ignition engines and compression ignition engines (e.g., diesel engines). However, the combustion modes employed within an engine structure may have characteristics of both engine types. For instance, a spark ignition engine might use a compression ignition combustion strategy in some portion of its operating range. A combination of fuels used within different combustion modes can be used to improve fuel efficiency while limiting regulated emissions within acceptable levels.

In spark ignition (SI) engines a high octane fuel is mixed with air upstream of the intake valves or the fuel is injected directly into the cylinder early in the compression process. As the piston approaches its smallest volume (clearance volume) at Top Dead Center (TDC), an electrical (or plasma) discharge creates a self-propagating flame front. The speed at which the combustion proceeds is referred to as the flame propagation speed. In order for an engine burning gasoline to operate reliably with spark ignition, the chemistry of the air and fuel should be close to stoichiometric. Other fuels such as natural gas are able to operate leaner relative to gasoline but eventually a point is reached where the fuel-air mixture becomes so lean that it does not burn completely. Also, if the air-fuel ratio is too lean for a given fuel, the flame propagation speed slows such that mis-fires can occur.

Because the fuel and air are pre-mixed in a spark ignition engine, the resistance to auto-ignition of the fuel (octane) must be sufficiently high to prevent abnormal combustion. Knock may occur when the fuel and air mixture begins to react before (or not solely because of) the spark event. In a knocking engine cycle, the spark initiates the flame front which propagates as in a normal cycle. However, as the propagating flame front heats and compresses the unburned gas in front of it, the unburned gas may react volumetrically, or all at once, if the fuel does not have sufficient auto ignition resistance (e.g., sufficient octane rating). It is known that knocking operation may limit hardware life. Reducing in-cylinder pressures prior to combustion may provide margin against knocking, but limiting the degree to which air is compressed in the engine (e.g., the compression ratio) may reduce thermal efficiency of the engine.

In order to control the amount of work a spark ignition engine produces, a throttle is used to control the amount of air and fuel mixture entering the cylinder. The operation of the throttle lowers the pressure in the cylinder and may create a parasitic power loss. When the conditions do not call for high power levels (for instance in highway cruising), and the throttle is closed, throttling loss occurs. Engine technologies like cylinder deactivation have become a popular way to increase the efficiency of spark ignition engines at light loads. A V-8 engine, for example, might shut off four of the eight cylinders. By doing this, the four cylinders that provide power are operating less throttled than they would be if the engine was producing the same power with eight cylinders. Deactivating cylinders is still more efficient despite the fact that all of the machinery of the deactivated cylinders is still in use.

A diesel engine operates by compressing air and injecting a fuel with an increased tendency to auto-ignite (measured according to a cetane value, for example) as the piston approaches TDC. Fuels for a diesel engine may include distillate diesel, biodiesel, propane, dimethyl ether, seed oils, combinations thereof, and other flammable fuels known in the art with similar cetane numbers. Diesel engines can be further classified into two broad categories, namely direct injection and indirect injection, depending on where the fuel is injected. Direct injection (DI) involves injecting the fuel into a volume that contains the moving piston. Conversely, indirect injection (IDI) may involve injecting the fuel into a static pre-chamber separate from the volume that contains the moving piston. Once fuel injection has begun, combustion does not begin until the fuel evaporates and mixes with oxygen. For this reason, diesel combustion is often called mixing-controlled combustion or diffusion combustion. In mixing-controlled combustion, fuel-air mixture burns around the periphery of the fuel jet as air entrainment occurs. (Dec, J., “A Conceptual Model of DI Diesel Combustion Based on Laser-Sheet Imaging,” SAE Technical Paper 970873, 1997, doi:10.4271/970873.) Locally, the combustion occurs at conditions which are richer relative to the global or average stoichiometric condition. Because combustion occurs while the fuel is being injected, there may be an overlap of time when liquid fuel or very rich mixtures are in the presence of hot combustion gases, which may generate soot.

The efficiency of any engine that uses expansion to produce work depends on a property of the gas known as the ratio of specific heats. A gas that has a higher specific heat ratio (˜1.4 for air at atmospheric conditions) will extract more work from a given working fluid when expanded by the same amount. This property is dependent in part on the constituents of the gas and its temperature. Monatomic gases such as argon have the highest specific heat ratio because all of the energy contained in the gas is stored in the translational energy of the atoms. Larger molecules such as CO₂ have additional energy storage modes such as rotation and vibration of the separate atoms in the CO₂ molecules. For any substance that has more than one atom, the ratio of specific heats is temperature dependent and decreases with increased temperature.

The temperature dependence of the specific heat ratio may provide an incentive to lower the combustion temperatures inside the engine. The combustion temperatures can be lowered by increasing the amount of air for a given amount of fuel. As described above, spark ignition engines have a limit of the degree to which the fuel can be diluted with air. Diesel engines do not have any such limitation as the combustion is the result of the fuel injection and subsequent mixing process. Operation with lean mixtures is one of the chief drivers of diesel engine efficiency relative to spark ignition engines. Alternatively, the combustion temperatures can be lowered by the introduction of the exhaust gas (EGR) into the intake stream (often passed through a cooler). The exhaust gas is depleted of oxygen and contains by-products of combustion which help to lower the combustion temperatures and improve the specific heat ratio. EGR is particularly useful in compression ignition engines. As the amount of EGR is increased the distance from the exit of the fuel spray to the point where combustion occurs, known as the flame lift-off length, increases. Understanding Diesel Spray Combustion, Lyle M. Pickett (8th International Symposium Towards Clean Diesel Engines TCDE 2011). EGR suppresses the combustion and allows more time for the jet to mix with air. This lowers the local combustion temperature which may further help to decrease engine regulated emissions. In supplying the engine with EGR some amount of air is removed from the intake stream. The reduction in the oxygen concentration often increases the amount of soot coming out of the engine.

A mixture of oxygen and nitrogen (such as air) may react to form oxides of nitrogen when the mixture temperature is raised above 2000 K. These oxides of nitrogen, including NO and NO₂ (hereinafter “NOx”), are regulated emissions in some jurisdictions.

Due to the heterogeneous nature of the combustion, Diesel engines tend to operate lean and therefore may not be compatible with 3-way catalysts used to convert NOx and/or unburned fuel in the exhaust of spark ignition engines. Some diesel engines use selective catalytic reduction (SCR) systems (perhaps in addition to other aftertreatment technologies) to mitigate any NOx that is formed in-cylinder.

Homogeneous charge compression ignition (HCCI) engines have evolved as a strategy to increase fuel economy and control exhaust emissions. HCCI uses a lean premixed fuel mixture which ignites through a compression ignition process. And because there is no separate fuel injected to ignite the mixture, the peak local temperature and the average temperature are the same (unlike a diesel or spark ignition engine). If the combustion temperature is low enough, no NOx will form, and because there are no local rich areas, no soot is formed. However, HCCI may pose combustion control challenges and may be sensitive to thermodynamic boundary conditions.

A combustion method known as reactivity controlled compression ignition (RCCI), is described in U.S. Pat. No. 8,616,177, entitled Engine Combustion Control via Fuel Reactivity Stratification, and the disclosure of which is incorporated by reference herein. RCCI uses the properties of two fuels to control the combustion. As an example, the two fuels may be gasoline (low reactivity) and diesel (high reactivity). A lean mixture (which may be supplemented by EGR) is used as the pre-mixed fuel, just as it might be with HCCI. However, unlike HCCI, a relatively small quantity of diesel fuel, with respect to the quantity of low reactivity fuel, may be injected to initiate combustion near the end of the compression stroke or near the beginning of the following expansion stroke.

With RCCI, the diesel fuel has a chance to mix with the gasoline and creates a fuel mixture that combines the easy-to-ignite tendency of diesel fuel with gasoline's ability to resist auto-ignition. Only small quantities of diesel fuel (approximately 15% of the combined fuel energy) may be sufficient to ignite all the fuel. Small amounts of injected fuel may prevent local rich areas which can create soot and high temperature areas which form NOx. Because the diesel fuel does not have enough time to completely mix with the gasoline, there may be concentration gradients of the diesel fuel such that the initial reaction occurs in the areas with the highest concentration and spreads to areas with lower concentration. This staged combustion event decreases the heat release rate relative to HCCI. Further, RCCI may have a higher load limit than HCCI combustion.

However, a need exists for improved apparatus and methods for controlling the combustion in internal combustion engines.

### SUMMARY OF THE INVENTION

The internal combustion engine of this disclosure has an engine block with a cylinder having a cylinder axis. A first part is mounted within the cylinder, and a second part is either a part of the engine block or another piston movable within the cylinder. The first part has a surface which faces a surface of the second part. The first part is movable within the cylinder along the axis to vary a distance between the surface of the first part and the surface of the second part.

Portions of the first part or of the second part define a barrier which extends axially within the cylinder to define a first zone and a second zone spaced radially from the first zone by the barrier. An air intake effects fluid communication between a source of air and the cylinder, and an injector is fluidly connected to a source of a first fuel, and disposed to inject the first fuel into the first zone within the cylinder.

A source of a second fuel is in fluid communication with the cylinder to introduce the second fuel substantially homogeneously into gases in the cylinder including the first and the second zone prior to the introduction of the first fuel into the first zone. The second fuel has a reactivity which is lower than a reactivity of the first fuel. The first part is actuated with respect to the second part to drive the first part closer to the second part to compress gases within the cylinder and cause combustion of the first fuel in the first zone prior to combustion of the second fuel in the second zone, the combustion of the first fuel in the first zone causes a quantity of hot gases to pass across the barrier to ignite the second fuel in the second zone.

A total clearance volume is defined between the first part, the second part, and a wall of the cylinder when the first part approaches most closely to the second part. An axial projection of the first zone defines a first chamber volume between the first part and the second part. A ratio of the first chamber volume to the total clearance volume when the first part most closely approaches the second part is 20 to 60 percent. A Top Dead Center position is determined when the first part most closely approaches the second part, and wherein the injector connected to the source of the first fuel is arranged to inject the first fuel into the cylinder at a crank angle position which is 10° to 30° before the Top Dead Center position. A first fuel may have a cetane number ranging from 40 to 60, and a second fuel has an octane number ranging from 90 to 130. The engine may be controlled by a controller operatively connected to the injector to control the time of injection and quantity of first fuel injected. The controller is responsive to signals received from sensors positioned within the engine.

Further objects, features and advantages of the disclosure will be apparent from the following detailed description when taken in conjunction with the accompanying drawings.

### BRIEF DESCRIPTION OF THE DRAWINGS

FIG. 1 is an isometric view of a piston an engine.

FIG. 2 is a cross-sectional view of the piston of FIG. 1 moving within an engine cylinder with a schematic indication of fuel, air, and recirculated exhaust gas inputs.

FIG. 3 is a fragmentary cross-sectional view of an alternative embodiment engine cylinder as a higher reactivity fuel is injected into a first zone.

FIG. 4 is a fragmentary cross-sectional view of the beginning of combustion within the cylinder of FIG. 3 in the first zone.

FIG. 5 is a fragmentary cross-sectional view of the cylinder of FIG. 4 as the combustion propagates from the first zone to a second zone.

FIG. 6 is a fragmentary cross-sectional view of the cylinder of FIG. 5 as combustion continues in the second zone.

FIG. 7 is a fragmentary cross-sectional view of the cylinder of FIG. 6 as combustion continues in the second zone and combustion gases are recirculated into the first zone from the second noze.

FIG. 8 is a fragmentary cross-sectional view of the cylinder of FIG. 7 as the recirculated combustion gases returning from the second zone cool the combustion gases in the first zone.

FIG. 9 is a schematic top view of the cylinder of FIG. 2, indicating the location of fuel injecting nozzles which introduce fuel into the radial inner region defined by the piston barrier.

FIG. 10 is an exploded isometric view of an alternative embodiment two-piston arrangement for an engine, in which the combustion is initiated in a radial outward region of the pistons.

### DESCRIPTION OF THE PREFERRED EMBODIMENTS

Spark ignition engines have a lean mixture limit after which incomplete combustion or misfires occur. Diesel engines do not have this limitation but the heterogeneous nature of the combustion creates an environment where carbon particles and nitrous oxides can form. The present engine addresses these problems by using a lean homogeneous mixture of a lower reactivity fuel in the engine cylinder and using a cylinder head or piston head shaped to divide the combustion volume into two combustion zones, for example one positioned radially outwardly of the other. Diesel fuel or other higher reactivity fuel is injected into the first zone resulting in mixture that ignites before the second zone. After ignition, the gases from the first zone flow through a slot defined by a barrier to the outer zone further compressing and igniting the lean mixture in the outer zone.

The second zone is less reactive than the first zone due to a lower concentration of high reactivity fuel or mixture homogeneity than the first zone. For this reason, the combustion products formed in the second zone contain more oxidizer and react at a lower temperature relative to the first zone. Combustion in the second zone creates a flow back into the first zone. The backflow will thereby provide cooling, increased fluid motion and oxidizer to the first zone The overall result is an engine which does not lose efficiency due to lean combustion like a spark ignition engine, but burns at lower temperatures like an HCCI engine and so avoids nitrous emissions.

The different reactivity components may be different fuels altogether, such as diesel and gasoline, or they may be similar fuels at different concentrations. The first volume could be the first region defined within an annular barrier on the piston, and the second volume could be a radially outwardly positioned region on the other side of the barrier. The barrier defines a constricted region through which gasses must pass to extend from the first volume to the second volume. The combustion in the first zone is limited by the amount of diesel fuel present in the first zone. The fuel in the first zone ignites very quickly such that the restriction created by the barrier at the top of the piston propels the combustion gas at high velocity into the second zone.

In the present engine, the conditions in the second zone are such that the lower reactivity fuel does not react instantly as it would with HCCI. Instead, the heat released in the inner zone creates circulation of hot gases which ignites the second zone. Critically, the combustion in the second zone occurs as hot gases in the outer zone are mixed together. The combustion that occurs in the outer zone is controlled by how fast it can be mixed together just as it is in a diesel engine and unlike a spark ignition engine which relies on the flame to propagate of its own accord. The mixing controlled combustion in the second zone is slow enough to prevent high pressure rise rates but not so slow as to lead to incomplete combustion.

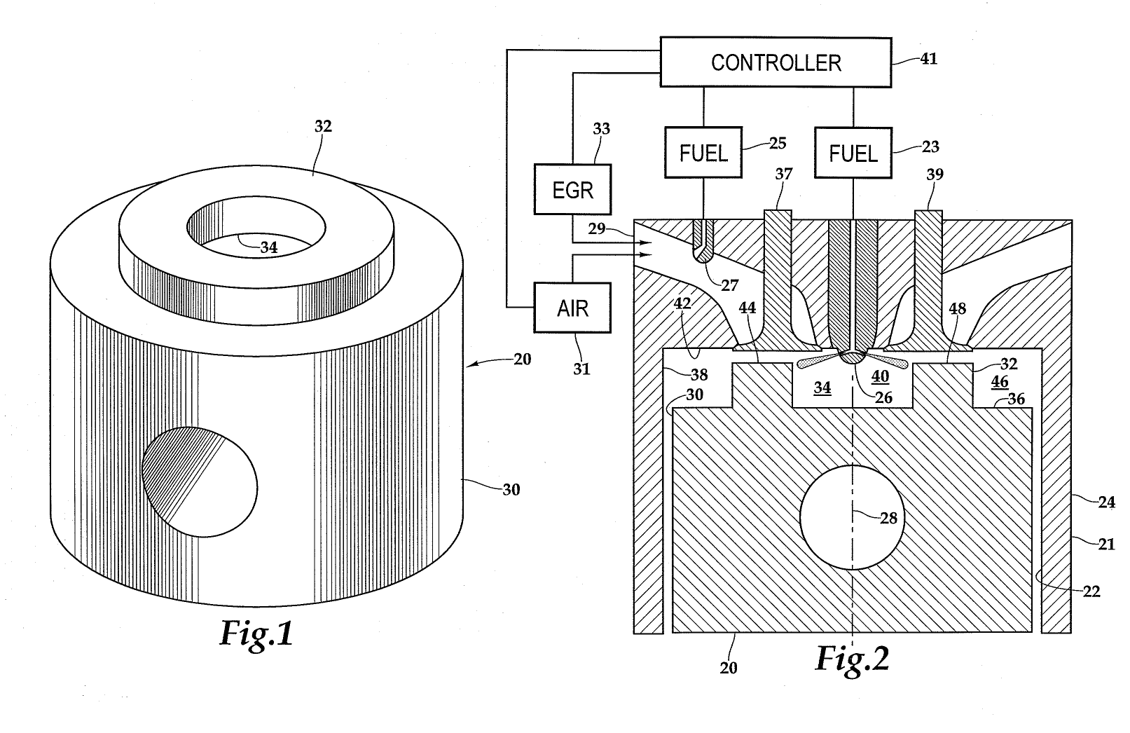

Aspects of the disclosure will now be described with reference to the drawings, wherein like numbers refer to similar parts. FIG. 1 shows an isometric view of a piston 20 for an internal combustion engine 21, according to an aspect of the disclosure. The piston 20 reciprocates within a cylinder 22, which defines a volume within an engine block 24, as shown in FIG. 2. The piston 20 may be connected to a power train (not shown) as known for conventional internal combustion engines. Although only a single cylinder is shown in FIG. 2, it will be appreciated that the engine 21 may include any number of cylinders as required for a particular application. According to an aspect of the disclosure, the engine 21 is a compression ignition engine which does not include or use an electrical spark ignition system, a spark plug, an ignition light source such as a laser, a plasma ignition system, or the like.

In operation the cylinder is provided with two fuels: a first fuel from a first fuel source 23, which is a higher reactivity fuel, which is introduced into the cylinder 22 through one or more injectors 26 as shown in FIG. 2; and a second fuel which is a low reactivity fuel, which is mixed with air upstream of the cylinder and is supplied to the cylinder as a lean air/fuel mixture or direct injected early to form a premixed mixture prior to the onset of combustion. By lean is meant an air/fuel ratio (AFR) of greater than the stoichiometric ratio, which varies depending on the fuel type or composition. The second fuel from a second fuel source 25 may be introduced through a second injector 27 in an inlet port 29 which is connected to a source of air 31 and which may also be connected to a source of exhaust gas recirculation (EGR) 33. The exhaust gas may be recirculated from the exhaust port 35, usually after flowing through a heat exchanger to lower its temperature. Valves 37, 39 are provided in the inlet port 29 and the exhaust port 35 to control the introduction and removal of gasses to and from the cylinder 22.

A controller 41, as shown in FIG. 2, is operatively connected to the sources of EGR, air, and fuel 33, 31, 25, 23 and the injector to control time of injection and quantity of fuel injected. The controller is responsive to signals received from sensors positioned within the engine. It will be understood that the controller will receive various inputs from the apparatus in which the engine is mounted, for example load requirement. The exhaust gas recirculation operation includes numerous conventional servos and input sensors throughout the engine and apparatus.

The piston 20 travels along an axis 28 defined by the cylinder 22, and compresses the gases contained within the cylinder as it travels from its lowest position at bottom dead center (BDC) to its highest position at top dead center (TDC). All timings are given in degrees ATDC (After Top Dead Center). The volume at TDC is known as the clearance volume. As shown in FIG. 1, the piston 20 has a cylindrical body 30 which has an axially protruding barrier 32 which may be an annular ring which defines a first zone 34 radially inward of the barrier, and a second zone 36 which is radially outward of the barrier. The piston body 30 may be provided with conventional grooves which receive piston rings (not shown), which form a moving seal with the walls 38 of the cylinder 22. As shown in FIG. 2, when the piston 20 is at TDC, the barrier 32 defines an inner chamber 40 with the cylinder head 42, which communicates through an intermediate passageway 44 with an outer chamber 46 also defined with respect to the cylinder head. The first zone 34 is defined within the inner chamber 40, and the second zone 36 is defined within the outer chamber 46.

When the piston 20 is at TDC, the top surface 48 of the barrier 32 does not engage the cylinder head 42 and remains spaced therefrom, as shown in FIG. 2. The distance between the top surface 48 of the barrier 32 and the cylinder head 42 is called the squish height, and it may be about 1 mm for cylinders having a volume of 0.3 to 4 liters, although this dimension may be larger for larger cylinders.

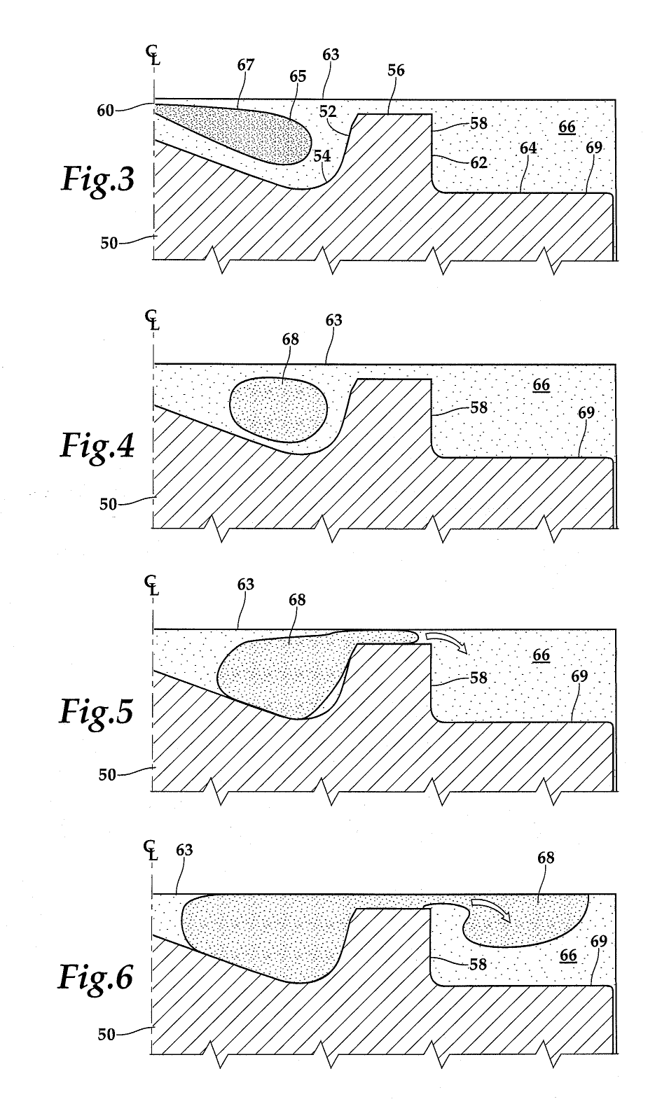

The operation of the engine 21 is shown in FIGS. 3-8, in which a partial cross-section through the cylinder 22 is shown, showing one half of the symmetrically arranged piston and cylinder head of an alternative embodiment piston 50. The piston 50 has an outwardly inclined inner barrier wall 52 which extends upwardly from a downwardly sloped inner chamber base wall 54. The intersection between the barrier wall 52 and the inner chamber base wall may have a smooth continuous curvature. The inner barrier wall 52 extends to the top wall 56 of the generally annular barrier 58. The top wall 56 is perpendicular to the cylinder axis 60 and extends to a barrier outer wall 62 which extends axially and which is perpendicular to an outer chamber base wall 64. The barrier 58 is positioned on the piston to define a first zone which is between 20 to 60 percent of the total clearance volume, in one preferred embodiment about 30 percent, the volume of the first zone being defined as a projection of the area within the barrier 58 to the cylinder head.

As shown in FIG. 3, the first fuel 65 is injected into the first zone 63 after the entire cylinder has been charged with a second air-fuel mixture 66. The second air/fuel mixture 66 is comprised of a second fuel, which is a lower reactivity fuel, for example gasoline, which has been premixed with air ahead of its introduction into the cylinder 22. The second fuel may have an octane number of from 90 to 130. Octane number may be ascertained according to ASTM D2700-13b, “Standard Test Method for Motor Octane Number of Spark-Ignition Engine Fuel.” The second air/fuel mixture 66 is a lean mixture, with an air/fuel ratio of between 50 to 15, depending on fuel type, and may be diluted with EGR at quantities depending on the load. As the piston 50 approaches TDC, the second air/fuel mixture 66 homogenously fills the volume of the cylinder. If the second fuel is direct injected into the cylinder the second fuel start of injection timing may be from −100° to −30° ATDC.

The liquid first fuel 65 is introduced through the injector 26 into the first zone 63 radially inward of the barrier 58 to create the first air/fuel mixture within the first zone. The first fuel is a fuel of greater reactivity than the second fuel. The first fuel is injected into the first zone before the contents are compressed enough to autoignite. The injected mixture flows outwardly to the inner barrier wall 52 during the ignition delay period.

The start of injection (SOI) timing of the first fuel is −30 to −5 ATDC, for example about −12°. The first fuel is a higher reactivity fuel, for example diesel fuel, preferably a fuel with a cetane number of 40 to 60. Cetane number may be ascertained according to ASTM D613-13, “Standard Test Method for Cetane Number of Diesel Fuel Oil.” The first fuel 65 in the form of minute droplets forms a zone 67 of a first air/fuel mixture within the first zone 63. The first fuel 65 is injected into the cylinder which has already been filled with a second air/fuel mixture 66.

It will be noted that the first fuel 65 is injected so late in the cycle that the first zone is never homogeneous. The second zone may be homogeneous, although note that it would not ignite without communication from the first zone.

As the piston 50 approaches TDC, as shown in FIG. 4, the contents of the cylinder volume are compressed sufficiently that there is volumetric combustion wherever the concentration of the first fuel is sufficiently high. The first air/fuel mixture is still within the first zone 63, and the combustion takes place first within the first zone, as shown by the region of combustion 68 in FIG. 4.

The combustion of the air/fuel mixture in the first zone yields a rapid heat release which drives the high reactivity mixture into the second zone or 69, Rapid heat release also insures that the gases entering the second zone are hot, with little time to cool as they enter the second zone. As shown in FIG. 5, the hot gases pass over the barrier extending through the narrow intermediate passageway 44 defined by the squish height above the barrier 58. The rapid heat release and the narrow passageway create a hot, high velocity gas that ignites the second air/fuel mixture within the second zone 69 radially outwardly of the barrier 58, as shown in FIG. 6.

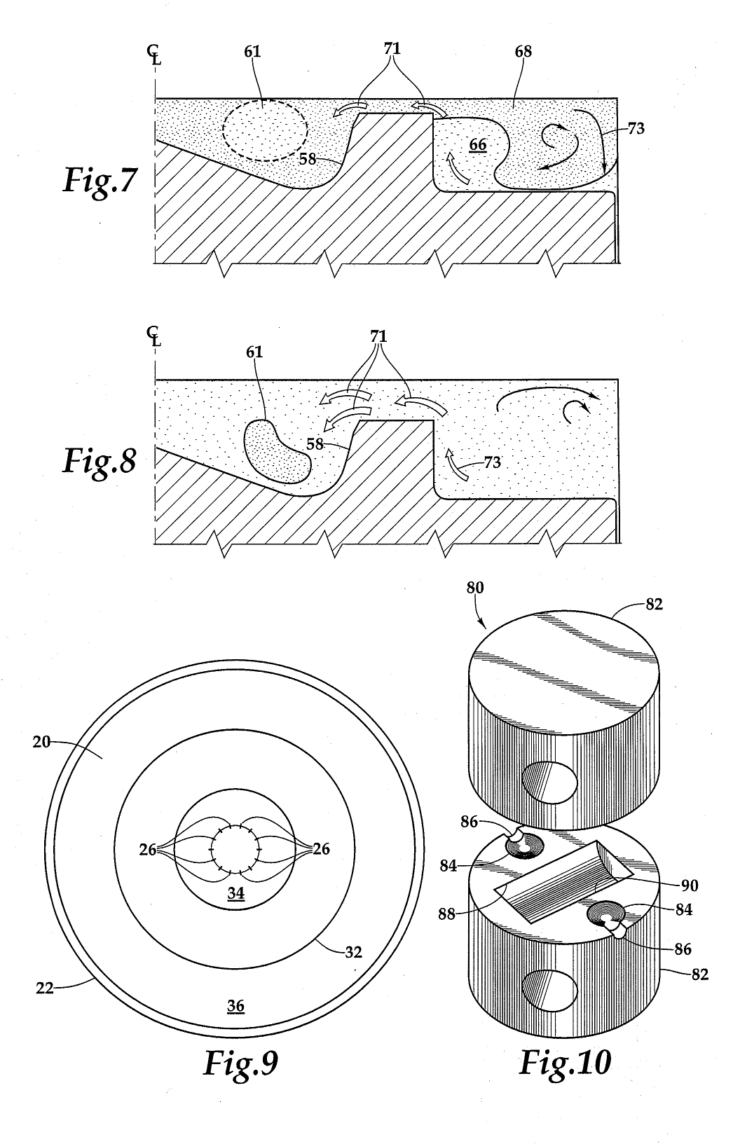

In FIG. 7, a hotter region of the combustion gases in the first chamber is indicated by the gray outline 61. After ignition in the first volume, pressure drives fluid into the second volume. The increase in pressure and temperature in the outer volume ignites the fuel mixture in the second volume. With the ignition of the second volume air/fuel mixture, the pressure in the outer chamber becomes greater than the pressure in the inner chamber. The combination of increased mass and pressure rise due to combustion drives fluid back into the inner chamber as indicated by the arrows 71 in FIGS. 7 and 8. The flow from the second volume cools the fluid in the first volume to suppress the formation of NOx. Hence, the hotter region 61 is reduced, as shown in FIG. 8. Because the wall temperatures cannot fluctuate as quickly as the gas temperature, the unburned gas temperatures of the fluid next to the walls tend to be lower than fluid which is further displaced from the wall. As shown by arrows 73 in FIGS. 7 and 8, the fluid motion between the first and second volumes wipes the cool gases from the wall to promote complete combustion. The backflow from the second volume to the first volume helps to completely combust any remaining unburned fuel products in the first volume. The shape of the barrier can create circulating flows in both volumes. The intersection of the barrier top wall 56 and the barrier outer wall 62 can be sharp, for example with a radius of 0.5 mm. Preferably, the barrier outer wall extends axially as shown to promote circulation.

A simulation of an engine of the type just described, suggests operating with a Brake Mean Effective Pressure (BMEP) of 18.3 bar, a compression ratio of 12.0 with an air-fuel ratio of 15, in an engine operating at 1200 and 1800 RPM, using exhaust gas recirculation (EGR) of 64 mass percent and a first fuel start of injection (SOI) timing of −5° and −30° ATDC. Another simulation has an air-fuel ratio of 22 and exhaust gas recirculation of 27. Yet another simulation with lighter loads has an air-fuel ratio of 55 with 0 EGR. It should be noted that with this type of combustion, the amount of EGR generally goes up with load. Hence there is no preferred range for the engine but rather a preferred range within the different load points in the engine's operating map. As load increases, more EGR is necessary to suppress ignition in the pre-mixed fuel. For example:

At light load (1 bar to 6 bar BMEP) AFR 35-50 and EGR % 0-40

At medium load (6 bar to 14 bar) AFR 22-35 and EGR % 20-40

At high load (14 bar to 20 bar) AFR 15-22 and EGR % 30-60.

The rate of combustion in the first zone 63 is controlled by the penetration distance of the first fuel injection and combustion in the second zone 69 is controlled by the rapid heat release in the first zone 63 and the high velocity gases created by the barrier restriction.

It should be noted that the second, lower reactivity fuel, is provided in the cylinder premix as an air/fuel mixture which may be combined outside the cylinder, such as with port fuel injection. However, very early introduction of the second fuel into the cylinder, giving sufficient time for mixing of the second fuel with air within the cylinder, could also be employed. The first fuel will preferably be injected as a liquid.

Although the first air/fuel mixture is of a higher reactivity than the second air/fuel mixture, and this will typically be achieved by employing a first fuel which is different from the second fuel, and inherently of greater reactivity, the higher reactivity of the first air/fuel mixture may be achieved by an increased concentration of the same fuel in the first air/fuel mixture when compared to a leaner concentration of fuel in the second air/fuel mixture. A higher concentration of the same fuel is more reactive and can ignite the first zone. Ignition of the second zone occurs when the hot high speed flow of gas mixes with the lower concentration and thus lower reactivity air/fuel mixture in the second zone beyond the barrier.

It should be noted that although the barrier has been illustrated on the piston in the above examples, it may alternatively be positioned on the cylinder head.

The injector 26, as shown in FIG. 2, is located above and within the first zone defined by the barrier 32. An advantage of injecting the first fuel only into the first zone is that the injected first fuel does not need to travel so far in filling the first zone as it would if it had to fill the entire cylinder volume. For example, if the spray penetration requirement is 80 percent of a volume that is just 20 to 60 percent of the clearance volume, then, as shown in FIG. 9, 14 injector nozzle holes with a diameter of 100 microns could be used in the place of the 7 injector nozzle holes with a diameter of 140 microns which might be used in a conventional diesel engine having a displacement of 0.5 liter per cylinder.

Although the first fuel has been illustrated as being injected into the first radial inward zone, it may alternatively be injected into the second or radial outward zone. In such an embodiment, the design of the injectors and the injection timing may be configured to project the first fuel into the second zone. The location of the injectors may remain radially inwardly of the barrier.

An alternative embodiment piston arrangement 80 in an engine is shown in FIG. 10, in which two pistons 82 are disposed within the cylinder moving towards and away from one another. Each moving piston has structure thereon which defines two zones with a dividing barrier. Instead of a single first zone and a single second zone, each piston 82 has two first zones 84 which may be semispherical recesses each having a radially extending channel 86 which communicates between the first zone and a fuel injector in the cylinder wall, not shown. The first zones 84 are separated by a barrier 88 from a single second zone 90. The second zone may be formed as a semicylindrical depression. When the two pistons make their closest approach to one another, there is a sufficient gap or squish height between the barriers 88 on the opposed pistons, for gases to pass from the first zones 84 to the second zone 90.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

1. A compression ignition combustion method for an internal combustion engine, a first part and a second part of the internal combustion engine defining a combustion chamber, the combustion chamber defining an axial direction, wherein the first part and the second part are movable with respect to one another in the axial direction, and wherein the first part has formed thereon a barrier projecting in the axial direction, the barrier defining a first zone spaced radially from a second zone within the combustion chamber, the method comprising:
supplying an initial fuel charge as an air/fuel mixture combined outside of the combustion chamber and injected through an inlet port into the combustion chamber;
supplying a subsequent fuel charge into the first zone of the combustion chamber after the supplying of the initial fuel charge, the subsequent fuel charge, as injected, having greater reactivity than the initial fuel charge; and
compressing the fuel charges within the combustion chamber to induce ignition and combustion of the fuel charges, the ignition and combustion of the fuel charges including burning the subsequent fuel charge within the first zone to produce hot gases, and flowing the hot gases across the barrier to effect combustion of the initial fuel charge within the second zone.

2. The method claim 1 wherein a total clearance volume is defined between the first part and the second part and a wall of a cylinder when the first part approaches most closely to the second part, and
wherein an axial projection of the first zone defines a first chamber volume between the first part and the second part; and
wherein a ratio of the first chamber volume to the total clearance volume when the first part most closely approaches the second part is 20 to 60 percent.

3. The method of claim 1 wherein a Top Dead Center position is determined when the first part most closely approaches the second part, and further comprising injecting the subsequent fuel charge into the combustion chamber within the first zone at a crank angle position which is 10° to 30° before the Top Dead Center position so as to have a lower peak cylinder pressure, peak heat release rate, and combustion generated noise while maintaining low unburned hydrocarbon and carbon monoxide emissions due to mixing caused by the hot gases which flow across the barrier, and to gases which flow back across the barrier from the second zone.

4. The method of claim 1 wherein a fuel supplied in the initial fuel charge has an octane number of 90 to 130, and wherein a fuel supplied in the subsequent fuel charge has a cetane number of 40 to 60.

5. A compression ignition combustion method for an internal combustion engine, a first part and a second part of the internal combustion engine defining a combustion chamber, the combustion chamber defining an axial direction, wherein the first part and the second part are movable with respect to one another in the axial direction, and wherein the first part has formed thereon a barrier projecting in the axial direction, the barrier defining a first zone spaced radially from a second zone within the combustion chamber, the method comprising:
supplying an initial fuel charge into a combustion chamber;
supplying a subsequent fuel charge into the first zone of the combustion chamber after the supplying the initial fuel charge, a composition of a fuel of the subsequent fuel charge being the same as a composition of a fuel of the initial fuel charge, and a concentration of the fuel of the subsequent fuel charge, in the subsequent fuel charge as injected, being greater than a concentration of the fuel of the initial fuel charge in the initial fuel charge; and
compressing the fuel charges within the combustion chamber to induce ignition and combustion of the fuel charges, the ignition and combustion of the fuel charges including burning the subsequent fuel charge within the first zone to produce hot gases, and flowing the hot gases across the barrier to effect combustion of the initial fuel charge within the second zone.

6. An internal combustion engine comprising:
an engine block defining a cylinder therein with an axis;
a first part mounted within the cylinder;
a second part forming a part of the engine block or mounted within the cylinder, a surface of the first part facing a surface of the second part, wherein the first part is movable within the cylinder along the axis to vary a distance between the surface of the first part and a surface of the second part;
a barrier defined by portions of the first part or the second part extending axially within the cylinder to define a first region and a second region spaced radially from the first region by the barrier;
an air intake for effecting fluid communication between a source of air and the cylinder;
an injector fluidly connected to a source of a first fuel, and disposed to inject said first fuel into the first region within the cylinder;
a source of a second fuel in fluid communication with the cylinder to introduce the second fuel substantially homogeneously into gases in the cylinder including the first and the second region prior to the introduction of the first fuel into the first region, a reactivity of the second fuel being lower than a reactivity of the first fuel; and
the first part being actuated with respect to the second part to drive the first part closer to the second part so as to compress gases within the cylinder and cause combustion of the first fuel in the first region prior to combustion of the second fuel in the second region, the combustion of the first fuel in the first region causing a quantity of hot gases to pass across the barrier to ignite the second fuel in the second region.

7. The engine of claim 6 wherein the second part composes at least a portion of a cylinder head which is fixed to the cylinder, and the first part comprises a piston which moves axially within the cylinder.

8. The engine of claim 6 wherein the first part and the second part are both pistons which move axially within the cylinder.

9. The engine of claim 6 wherein the first region is disposed radially inward from the second region.

10. The engine of claim 6 wherein the first region is disposed radially outward from the second region.

11. The engine of claim 6 wherein a total clearance volume is defined between the first part, the second part, and a wall of the cylinder when the first part approaches most closely to the second part,
wherein an axial projection of the first region defines a first chamber volume between the first part and the second part; and
wherein a ratio of the first chamber volume to the total clearance volume when the first part most closely approaches the second part is 20 to 60 percent.

12. The engine of claim 6 wherein a Top Dead Center position is determined when the first part most closely approaches the second part, and wherein the injector connected to the source of the first fuel is arranged to inject the first fuel into the cylinder at a crank angle position which is 10° to 30° before the Top Dead Center position.

13. The engine of claim 12, wherein the injector connected to the source of the first fuel is arranged to inject the first fuel into the cylinder at a crank angle position which is about 12° before the Top Dead Center position.

14. The engine of claim 6 wherein a fuel supplied by the source of the first fuel has a cetane number ranging from 40 to 60, and a fuel supplied by the source of the second fuel has an octane number ranging from 90 to 130.

15. The engine of claim 6 further comprising a controller operatively connected to the injector to control time of injection and quantity of first fuel injected, the controller responsive to signals received from sensors positioned within the engine.

16. A compression combustion method for a diesel internal combustion engine, the method comprising the steps of:
supplying a substantially homogeneous charge of fuel and combustion air into a cylindrical combustion chamber of the diesel internal combustion engine, wherein the cylindrical combustion chamber defines a cylinder axis;
wherein when the engine has a BMEP of 1 to 6 bar the charge has an AFR of 35 to 50 and an EGR % of 0 to 40, when the engine has a BMEP of 6 to 14 bar the charge has an AFR of 22 to 35 and EGR % of 20 to 40, and when the engine has a BMEP of 14 to 22 bar the charge has an AFR of 15 to 35 and an EGR % of 30 to 60;
wherein a combustion chamber is defined between a cylindrical wall of an engine block and a piston and a second piston or a piston head formed by the engine block;
wherein the piston is movable with respect to the second piston or the piston head;
wherein the piston or the piston head has formed thereon an axially projecting barrier, the barrier defining a first zone spaced radially from a second zone within the combustion chamber;
igniting one of the first zone and the second zone defining a first ignited zone by injecting fuel when the piston is between 30° and 1 ∞ before top dead center into one of the first zone and the second zone, creating a fuel rich volume, and further compressing the charge as the piston moves to top dead center until the fuel rich volume ignites; and
igniting the other of the first zone or the second zone, by allowing combustion gases to flow over the axially projecting barrier through a gap between the barrier and a cylinder head or a second piston so that the flow accelerates through the gap in a first direction and compresses and ignites a portion of the charge in the other of the first or second zone, wherein the portion of the charge of the other of the first or second zone, after ignition, expands and causes a flow through the gap in a second direction opposite the first direction which enters the first ignited zone and lowers a temperature of the first ignited zone.

17. The method of claim 16 wherein the fuel in the charge is of a lower reactivity than the fuel injected into one of the first zone and the second zone.

18. The method of claim 17 wherein the fuel in the charge has an octane number of 90 to 130 and the fuel injected into one of the first zone and the second zone has a cetane number which is from 40 to 60.

19. The method of claim 16 wherein the combustion chamber is defined between the cylindrical wall of the engine block and the piston and the second piston, and wherein the piston and the second piston move with respect to each other and with respect to the engine block.

20. The method of claim 16 wherein the step of supplying a substantially homogeneous fuel and combustion air containing charge into the cylindrical combustion chamber of the diesel combustion engine is completed by injection of the fuel in to the cylindrical combustion chamber when the piston is between 80° and 30° before top dead center.

21. The method of claim 16 wherein the igniting of one of the first zone and the second zone by injecting fuel is carried out when the piston is at about 12° before top dead center.

22. The method of claim 16 wherein the combustion chamber has a clearance volume when the piston is at top dead center, and wherein a volume of the first ignited zone when the piston at top dead center is about 30 percent of the clearance volume.
